(19) United States
(12) Patent Application Publication
(10) Pub. No.: US 2016/0239860 A1
(43) Pub. Date: Aug. 18, 2016

(54) A METHOD OF ENABLING A CUSTOMER PROFILE

(71) Applicant: ECREBO LIMITED, Marlow Buckinghamshire (GB)

(72) Inventors: YOSUKE OZAWA, MARLOW BUCKINGHAMSHIRE (GB); ROMAN VALIUSENKO, MARLOW BUCKINGHAMSHIRE (GB); HASSAN HAJJI, MARLOW BUCKINGHAMSHIRE (GB); TERUO KOYANAGI, MARLOW BUCKINGHAMSHIRE (GB)

(21) Appl. No.: 14/917,391

(22) PCT Filed: Sep. 10, 2014
(86) PCT No.: PCT/GB2014/052746

§ 371 Date: Mar. 8, 2016

(30) Foreign Application Priority Data
Sep. 10, 2013 (GB) 1316083.3

(51) Int. Cl. G06Q 30/02; G06Q 20/40; G06Q 20/38; H04L 29/08

(52) U.S. Cl. CPC G06Q 30/0226; H04L 67/306; G06Q 20/40; G06Q 20/382

(57) ABSTRACT

A method of establishing a user profile on a server computer, the user profile being associated with a unique user identifier used during a transaction made by a user, the method comprising: receiving user-related data comprising identification data associated with the unique user identifier; sending a server authentication message to the user in dependence on the user related data; receiving a registration message from the user, the message comprising the authentication message; establishing the user profile in response to receiving the registration message

### TECHNICAL FIELD

The present invention relates to a method of enabling a customer profile. In particular the present invention relates to a system and method for issuing transaction offers to a user.

### BACKGROUND TO THE INVENTION

Loyalty programs are marketing tools to encourage loyal buying behaviour among customers by rewarding incentives for customer's purchases, taking into account such information as frequency of purchases, amount of money spent, and all other collected information about the given customer. Common practice to enable such loyalty programs is to introduce plastic loyalty cards that are used as a medium to associate collected points with a customer. Many companies such as flight companies, pharmacy, large retailer networks all have their loyalty cards and programs.

Due to the increased number of loyalty cards that customers use a need to help organize loyalty cards has emerged, with a shift towards electronic loyalty cards, mobile loyalty, or an on-line loyalty programs has been noticed. However, retailers still need to implement integration with these systems and that may be a serious impediment for smaller retailers due to technical requirements or implementation costs.

It is also noted that implementing loyalty programs may be associated with a need for customer to provide personal data. Data protection issues and a reluctance to provide personal data may provide a barrier to customer take up of such programs.

It is an object of the present invention to provide an offer issuing system that overcomes or substantially mitigates the above mentioned problems.

### SUMMARY OF THE INVENTION

According to a first aspect of the present invention there is provided a method of establishing a user profile on a server computer, the user profile being associated with a unique user identifier used during a transaction made by a user, the method comprising: receiving user-related data comprising identification data associated with the unique user identifier; sending a server authentication message to the user in dependence on the user related data; receiving a registration message from the user, the message comprising the authentication message; establishing the user profile in response to receiving the registration message.

The present invention provides a method of establishing a user (customer) profile that may be used, for example, with a loyalty system for providing transaction offers to a user. Rather than requiring the user to enter personal data in order to complete a registration process the present invention comprises a server computer that is arranged to receive user-related data in the form of identification data associated with a unique user identifier. For example, the unique user identifier may comprise a transaction card or loyalty card number and the server computer may either receive such data from a payment terminal (such as a point of sale terminal) or may receive a cryptographically hashed version of such data. In response the server computer may send a server authentication message to the user in dependence on the user related data. The server authentication message may conveniently be sent to the user via a payment terminal. For example, the server computer may be arranged to return a server signed version of the received user-related data in the form of a barcode, quick response code, passcode, 2D barcode etc. that may be printed on a transaction receipt. In response to receiving such a server authentication message a user may send a registration message to the server computer that comprises the server authentication message and the server computer may then establish the user profile.

The registration message from the user may be generated, for example, by the user either scanning a barcode with a mobile computing device (such as a smartphone like an iPhone® or Samsung® Galaxy® S44) or entering a passcode into a suitable application which then generates the registration message to send to the server computer. As noted above the barcode/passcode may be incorporated onto a receipt printed at the payment terminal and may comprise information sent from the server computer.

Upon receipt of the registration message the server computer may establish the user profile. It is noted that the method of the present invention does not require the user to enter personal data over and above information that is already part of a transaction process.

The method of the present invention enables the validation and redemption of collected points or stamps using an Internet enabled device such as a mobile device (phone), tablet computer, etc.

Conveniently, the user-related data may comprise a transaction identifier relating to the transaction, e.g the payment terminal may assign an arbitrary transaction number to each transaction it process and may send this to the server computer. Alternatively, the server computer may be arranged to apply a transaction identifier to received user-related data.

Conveniently, the registration message may comprise a unique device identifier corresponding to a user computing device. For example, the user computing device may be a mobile communications device such as a smartphone and the unique device identifier may be a International Mobile Station Equipment Identity or IMEI number. The unique device identifier may be incorporated into the user profile that the server computer establishes along with the user-related data.

Preferably, the method may comprise receiving further user-related data comprising identification data associated with the unique user identifier; sending a further server authentication message to the user in dependence on the further user related data; receiving a further registration message from the user, the message comprising the further authentication message; confirming the user profile in response to receiving the further registration message. The further user-related data and subsequent exchange above relates to a confirmation exchange between the server computer and the user to confirm they wish to establish a user profile. Conveniently the further user-related data may comprise a further transaction identifier relating to a further transaction.

Transaction identifiers may be assigned by a payment terminal to a transaction, each transaction being assigned a different transaction identifier.

The unique user identifier may comprise an account number associated with a user transaction device (a user transaction device comprising a traditional bank payment card, an electronic wallet, a near field communications enabled mobile device with a suitable electronic payment system etc.).

The unique user identifier may also comprise an account number associated with a user loyalty card or electronic loyalty card (e.g. on a suitably enabled mobile device).

Preferably, the identification data received by the server computer may comprise a cryptographically hashed version of the unique user identifier. By hashing the identifier provides a security feature in that no user-related data is sent “in the clear” to the server and the server in turn will not hold the actual transaction card details of the user.

The server computer may associate the received identification data with an initial status flag. The server computer may be arranged to update the status flag to a pending status upon receipt of the registration message. The server computer may be arranged to update the status flag to a confirmed status upon receipt of a further registration message.

The authentication message may comprise a digitally signed copy of the transaction identifier and the server computer may verify the validity of the transaction identifier received in the registration message.

The user-related data may also comprise transaction data (e.g. details of goods and/or services bought by the user in the transaction) and the server computer may be arranged to store the transaction data. In such a manner the user profile may build up a transaction history for the user.

The server authentication message may be sent to a payment terminal and may comprise a passcode or an image (e.g. a barcode, 2D barcode or quick response code).

According to a second aspect of the present invention there is provided a method of processing transaction data in dependence a user profile, the user profile having been established according to the method of the first aspect of the present invention, the method comprising: receiving transaction data related to a user transaction; storing the received transaction data and associating the received transaction data with the user profile to create a transaction history for the user.

The method of the second aspect of the present invention may comprise comparing the transaction history of the user against a stored transaction offer, the transaction offer being associated with an issuance condition, and issuing the transaction offer to the user in the event that the issuance condition is satisfied by the transaction history of the user.

The transaction offer may be sent to a user computing device (e.g. a mobile computing device) or a payment terminal.

The server computer may compare the transaction history against a plurality of stored transaction offers.

The present invention extends to a carrier medium for carrying a computer readable code for server computer to carry out the method of the first and second aspects of the present invention.

The invention extends to a carrier medium for carrying a computer readable code for controlling a computer or POS terminal to carry out the method of the first and second aspects of the invention.

According to a third aspect of the present invention there is provided a server computer arranged to establish a user profile, the user profile being associated with a unique user identifier used during a transaction made by a user, comprising: an input; a processor; an output; wherein the input is arranged to receive user-related data comprising identification data associated with the unique user identifier, the processor is arranged to generate a server authentication message in dependence on the user related data and the output is arranged to send the server authentication message to the user, and wherein the input is arranged to receive a registration message from the user, the message comprising the authentication message and the processor is arranged to establish the user profile in response to the registration message.

According to a fourth aspect of the present invention there is provided a server computer arranged to process transaction data in dependence a user profile, comprising a server computer according to the third aspect of the present invention wherein the input is arranged to receive transaction data related to a user transaction and the processor is arranged to store the received transaction data and associate the received transaction data with the user profile to create a transaction history for the user.

According to a fifth aspect of the present invention there is provided a method of establishing a user profile on a server computer, the user profile being associated with a unique user identifier used during a transaction made by a user on at a payment terminal, the method comprising: sending user-related data comprising identification data associated with the unique user identifier from the payment terminal to the server computer; sending from the server computer a server authentication message to the user in dependence on the user related data; sending a registration message from the user to the server computer, the message comprising the authentication message; establishing the user profile in response to receiving the registration message at the server computer.

The invention extends to a carrier medium for carrying a computer readable code for controlling a computer system to carry out the method of the fifth aspect of the invention.

It will be appreciated that preferred and/or optional features of the first and second aspects of the invention may be provided in the third, fourth and fifth aspects of the invention also, either alone or in appropriate combinations.

The present invention provides a secure and simple method and system to enable a loyalty program with the following features:
1. A secure and simple way to associate a customer's loyalty account with the customer's identifiers (e.g. credit/debit/loyalty cards etc.).
2. A system for managing a customer's rewards.
3. A system for evaluating/measuring a customer's loyalty.
4. A system for providing conditional issuance of offers to customers (e.g. somebody who has collected 10 points gets a free coffee offer).
5. A system for providing an offers validation and redemption mechanism.
6. A system comprising an audit mechanism.

The method and system according to embodiments of the present invention described herein comprise the following core features:
1. User Registration & SUID and User-ID Association;
2. Loyalty Index Calculation & Reward Issuance;
3. SUID and Subsequent Transactions Association;
4. Rewards Validation & Redemption;

The above operations may operate on a Customer Profile. User registration may create a User-ID, which uniquely identifies the customer within Loyalty Program system. SUID and User-ID Association may be the operation that creates links between SUIDs and User-IDs in Customer Profiles. Loyalty Index Calculation may use various loyalty index function to evaluate customer's loyalty, these functions take the whole Customer Profile to evaluate loyalty. Rewards Issuance may occur depending on reward issuance conditions and customer's loyalty evaluated by loyalty index functions. SUID and Subsequent Transaction Association operation may associate transaction data with SUIDs or User-IDs. Rewards Validation operation may check if the given Redemption Passcode is valid and that it can be redeemed. Redemption operation may associate transaction data with the given Redemption Passcode, supplied at validation step, and identify Customer Profile which includes the reward associated with the Redemption Passcode; it may also update corresponding Reward Meta-data to reference to the transaction which includes the redemption.

Embodiments of the present invention may also be associated with a number of security considerations, namely
1. Validation commands (password checks or Redemption Passcode validation) sent to Loyalty Program Server impose delayed response in case of failure to prevent brute force attacks.
2. Depending on system configuration, user-related data corresponding to a user's unique identifier may not be sent over the network at any point and may not be stored by the loyalty program system in the data store.
3. Transaction data may be amended by the Loyalty Program Enhancer before sending it to Loyalty Program Server in such a way that the user's unique identifier becomes unobtainable.
4. The user is not required to enter any personal or sensitive information except scan code images or input one-time passwords.
5. Scan codes and one-time passwords generated by the system may not convey any sensitive or personal information.
6. Scan codes may be optionally digitally signed.

### BRIEF DESCRIPTION OF THE DRAWINGS

In order that the invention may be more readily understood, preferred non-limiting embodiments thereof will now be described with reference to the accompanying drawings, in which:

FIG. 1 shows a known point-of-sale (POS) till configuration;

FIG. 2 shows an OPOS architecture;

FIG. 3 shows an OPOS architecture in accordance with an embodiment of the present invention;

FIG. 4 shows a known filter driver architecture;

FIG. 5 shows a filter driver architecture in accordance with an embodiment of the present invention;

FIG. 6 shows a known API structure; and

FIG. 7 shows a filter driver using hooked APIs in accordance with an embodiment of the present invention;

FIGS. 8a to 8c show further point of sale system arrangements that may be used in conjunction with embodiments of the present invention;

FIG. 9 shows server computer in accordance with embodiments of the present invention;

FIG. 10 shows how the state of a transaction card within the server computer may be flagged according to embodiments of the present invention;

FIG. 11 shows a registration process according to an embodiment of the present invention;

FIG. 12 shows a process of associating a unique user identifier with a user-ID in accordance with an embodiment of the present invention;

FIG. 13 shows a registration process in accordance with a further embodiment of the present invention;

FIG. 14 shows a process for establishing received transaction data with a user-ID in accordance with an embodiment of the present invention;

FIG. 15 shows a transaction offer issuance process in accordance with an embodiment of the present invention;

FIG. 16 shows the process of a transaction offer redemption process in accordance with an embodiment of the present invention;

FIG. 17 shows an overview of a user profile in accordance with an embodiment of the present invention;

FIGS. 18 to 22 show example screenshots of a payment terminal configured to process transaction offers in accordance with an embodiment of the present invention.

### DETAILED DESCRIPTION OF THE INVENTION

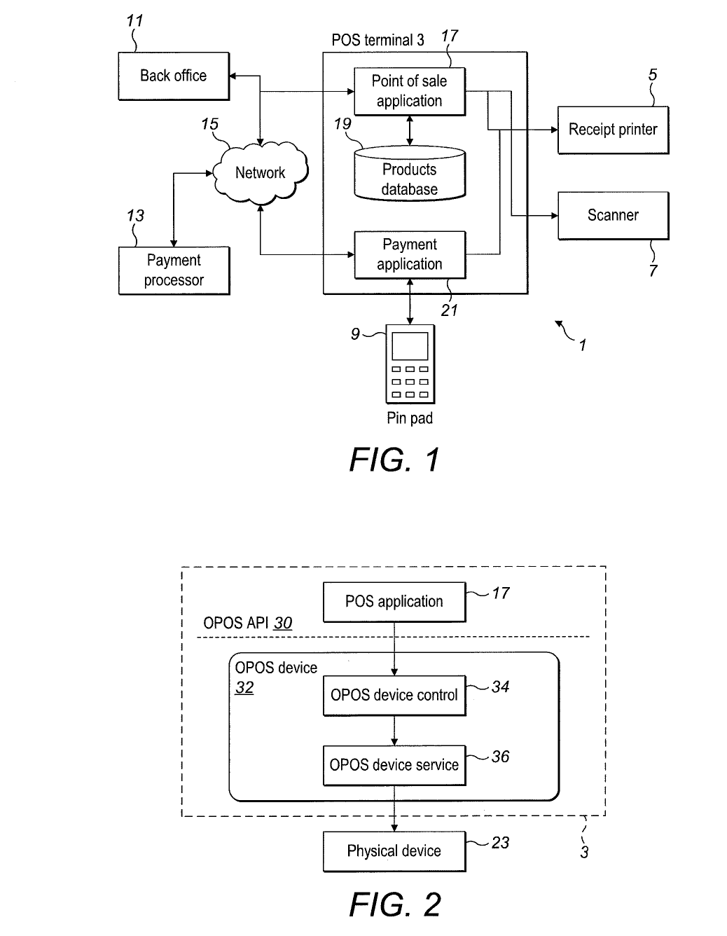

FIG. 1 shows a typical POS configuration for a point-of sale system 1 comprising a POS terminal 3, a receipt printer 5, a barcode scanner 7, a data entry device 9 for the entry of PIN codes (the “Pin Pad”), back-office servers 11 and a payment processing server 13. The POS terminal, back-office servers 11 and payment processing server 13 are in communication with one another via a network 15 (which may be a local network, the Internet or a mixture of both).

The POS terminal 3 comprises a point of sale application software module 17, which is in communication with a product database 19, and a payment application software module 21.

The point of sale application software module 17 and payment application software module 21 are each in communication with the receipt printer 5 and scanner 7 and with the back-office servers 11 and payment processing server 13 via the network 15.

The point of sale application software module 17 is responsible for recording items to be sold one by one, calculating the total balance, triggering any pre-configured promotions, and then accepting multiple payment methods. Typically, items are input in using the scanner 7. Items having barcodes printed on external packaging will be placed in front of the scanner 7 which then scans the barcode and passes the barcode as input to the POS software module 17. The POS software module 17 will then query the local database 19 to retrieve the price of the item which may be displayed on a screen (not shown in FIG. 1).

Once all items are scanned, the cashier asks the customer to confirm their preferred payment type to use, and if the user chooses to pay by card, the POS software module 17 connects to the payment application software module 21.

The payment application software module 21 drives an external device 9 to get the credit card details and optionally the PIN associated with the card. In cases where a PIN code is not required, the payment application software module may interface with a magnetic strip reader (which may be integrated with the device 9) which reads the card details when the user or cashier swipes the card through the strip reader.

Once the transaction is paid for, the POS application software module 17 formats details of the transaction and sends them to the receipt printer 5. In many cases, two or more receipts are printed: one for the customer, and one of the retailer. It is noted that the retailer copy of the receipt can potentially contain more information than the customer one (for e.g. full card details, while the customer receipt contains only the last 4 digits of the card used).

The payment application software module 21 is responsible for authenticating the card, verifying the PIN, and authorising the card for payment. This is done by accessing the payment processor 13 over the network connection 15. The payment processor 13 may be either hosted inside or outside the premises of the retailer, and in the case it is hosted outside the retailer's premises, the network path from the payment application software module 21 to the payment processor 13 may involve leaving the retailer's local computer network and using the Internet or other communications network (e.g. dedicated communications network or a mobile telecommunications network). The network 15 is also used by the POS application software module 17 to send transaction details to the back-office servers 11.

The POS application software module 17 typically runs on a commodity operating system (e.g. Microsoft Windows or Linux). Each of the devices external to the POS terminal 3 is connected to the machine using standard connectors: Serial, Parallel, USB, or Ethernet ports. To simplify the interoperability between POS software and payment software vendors and external devices vendors, a consortium of companies led by Microsoft, NCR, Epson, and Fujitsu-ICL standardised the interface between each device. These standards are typically implemented in Java or COM technologies, and known under the name of JAVAPOS or OPOS.

It is noted that OPOS is an implementation of an interoperability standard for a Windows® operating system using Component Object Model (COM) technology. OPOS defines a set of control objects that define the interface of each device, and a set of service objects that implement the interface above, in a set of libraries called service objects. Typically, the service object is provided by the hardware provider (e.g. Epson for the printers).

JAVAPOS is the implementation of the standard in JAVA language. It uses the same architecture as OPOS, with a set of JAVA classes defining the interface of the API, and another set of JAVA classes defining the implementation of these interfaces, called service objects. Typically, the manufactures provides the implementation for these service objects in JAVA.

FIG. 2 shows a typical layout of the component of OPOS used to interface between a physical device 23 (e.g. the printer 5 or scanner 7 of FIG. 1) and the POS application software module 17. The POS application software module 17 is arranged to access the physical device 23 using a standard OPOS application programming interface (API) 30. Communication between the POS application software module 17 and the physical hardware device 23 is handled by an OPOS device 32 (which is actually a software stack within the POS terminal 3).

The OPOS device comprises an OPOS device control module 34 which provides the interface for the POS application software module 17 and an OPOS device service module 36 which provides communication to the device 23.

The OPOS Device Service module 36 implements the details of the physical device 23 and is typically provided by the hardware vendor. For example, to print receipt data, the POS application software module 17 may call the following method:
PrintNormal(Integer Station, String DataToBePrinted):
Prints the data specified in “DataToBePrinted” to the station specified in parameter “Station”. This is guaranteed to work regardless of the underlying printer attached to the POS terminal 3.

Similar APIs exist for the scanner 7 as well. For example, regardless of the scanner attached to the POS terminal 3, the scanner property called “ScanData” always holds the scanned data. The POS application software module 17 upon receiving a read event from the scanner, can read this data, and it is guaranteed to hold the barcode of the item scanned.

An arrangement mirroring that of FIG. 2 may also be used to describe a JAVAPOS system for interfacing a POS software module with a hardware device.

To access the stream of data sent by the POS application software module 17 requires a change in the application so that appropriate code can be added in order to access the data.

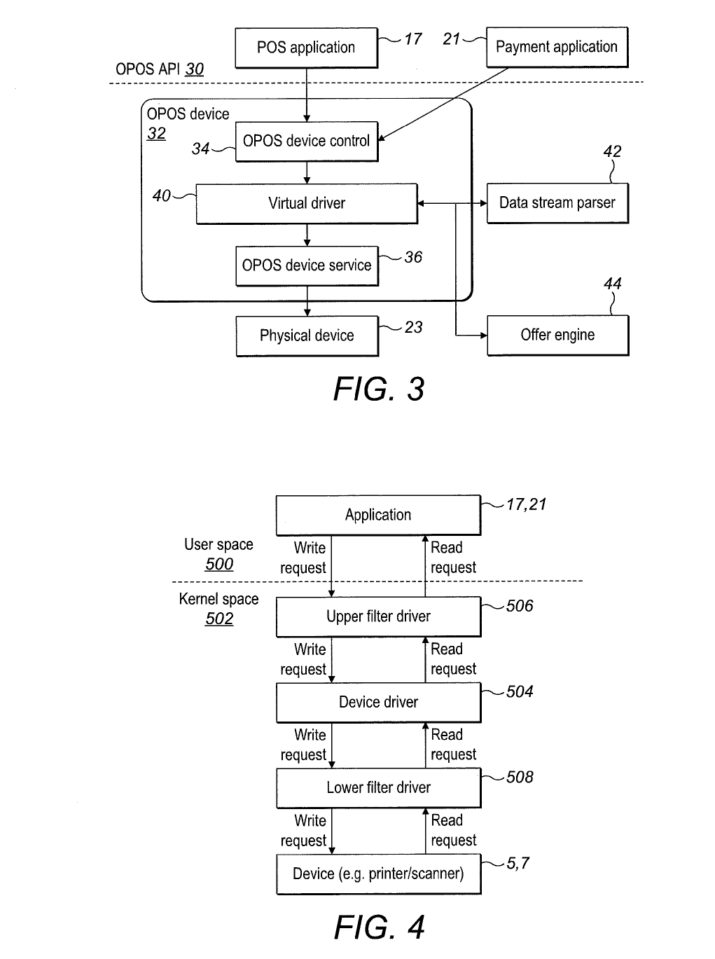

FIG. 3 shows a POS system suitable for use with embodiments of the present invention. It is noted that like numerals are used to denote like features throughout the claim set.

The architecture depicted in FIG. 3 is similar to the known OPOS architecture of FIG. 2. The OPOS device 32 however now additionally comprises a virtual physical driver software module 40 that is located between the OPOS device control module 34 and the OPOS device service module 36.

The inclusion of the driver software module 40 enables data communications to and from the POS application software module 17 or payment application software module 21 to the physical device 23 to be monitored and intercepted. The driver software module 40 also enables data communications that originate from outside the POS system 1 to be inserted into the OPOS device 32 and routed to either the physical device 23 or the POS application 17/payment application 21 software modules. In this manner information relating to transactions can be extracted from the POS system 1 and additional information can be added into the communication path between the POS terminal 3 and physical devices (5, 7).

In more detail the virtual driver software module 40 may be installed and operated as follows:

In an installation step the virtual physical driver software module 40 may be installed onto the POS terminal 3 such that it sits between the OPOS device control software module 34 and the OPOS device service software module 36.

In a first operational step, each command passed through from either the POS application software module 17 or the payment application software module 21 to the physical device 23 may be monitored and passed to a data stream parser module 42.

In a second operational step, the data stream parser module 42 may parse the data to create a list of transaction items; total amount spent; details of any promotions; cashier name or id; and/or any other data of interest. The data stream parser 42 may be achieved using a regular expression parser. The stream parser 42 may also parse the details of the cards used (either partial details, such as last 4 card digits and expiry date, or complete details if available). It is noted that since the payment application software module 21 uses the stack OPOS device 32, the virtual physical driver module 40 may also intercept any extra information used when printing the retailer receipt (in case the retailer receipt contains full card details).

In a third operational step the virtual physical driver module 40 may pass the card and transaction data derived in the second step above to a computing device 44. The computing device 44 may comprise a module associated with the POS system 1, a separate local computing device or a remotely located device. (It is noted that the computing device 44 is also referred to herein as a “transaction computing device”)

In a fourth operational step the computing device 44 may return modified data to the virtual physical driver module 40 which can then be supplied via the OPOS device service software module 36 to the physical device 23. In the example where the physical device 23 is the receipt printer 5 this allows the modified data (or a part or representation thereof) to be printed onto the customer's receipt.

In one example the computing device 44 may be an offer engine and depending on rules pre-set within the offer engine (e.g. to serve an offer to any customer who spent more than £20), the offer engine may generate an offer and pass it to the virtual physical driver module 40 for printing. Once the standard receipt data (e.g. store details, transaction items, transaction details etc.) has been printed, the virtual physical driver module 40 may print the offer received above to the POS system's receipt printer 5.

The virtual physical driver module 40 described above allows existing POS hardware to be used without any alterations to achieve the following:
Intercept transaction details without needing to modify the POS application software module 17;
Provide information from a computing device 44 to a customer using existing hardware (i.e. the receipt printer 5);
Associate transaction details with card details to thereby enable a loyalty scheme to be operated without any sign-up or loyalty cards to be used.

It is also noted that a POS terminal software module (either POS application software module 17 or Payment application software module 21) may in certain circumstances communicate directly with a physical hardware device rather than using an OPOS or JAVAPOS interface. Two alternative arrangements are therefore envisaged: (i) the software module (17, 21) may use ESC/POS (a command language used to drive receipt printers) or a similar language to directly to write to a serial port on the hardware device or to a USB device, or (ii) the software module may use a high-level printing API (for e.g. Windows printing architecture) and send rasterised data to the connected hardware device.

In arrangement (i) above, the data sent to the printer is a digital copy of the receipt and can be parsed as text. In arrangement (ii) above, the data sent to the printer is binary, and a parsing program would not be able to readily recover the details of the transactions.

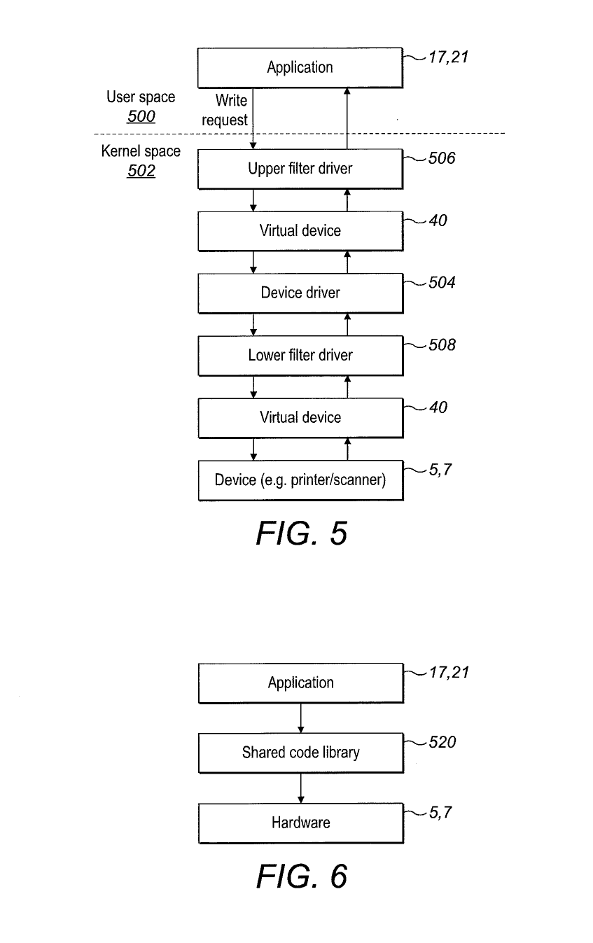

In arrangement (i), the virtual driver software module 40 may be implemented as a filter driver as shown in FIGS. 4 and 5. FIG. 5 shows a known POS terminal environment prior to modification in accordance with an embodiment of the present invention comprising a user space 500 and a kernel space 502 in which an application 17, 21 may read and write data to a physical device (5, 7) via a device driver 504 and upper (506) and lower (508) filter drivers.

It is noted that filter drivers are Microsoft Windows drivers that add value to peripheral devices or support specialized devices in a computing device. A filter driver is a driver/program/module that is inserted into an existing driver stack to perform some specific function. A filter driver should not affect the normal working of the existing driver stack in any major way. Written either by Microsoft® or the vendor of the hardware, any number of filter drivers can be added to Windows®. Upper level filter drivers sit above the primary driver for the device (the function driver), while lower level filter drivers sit below the function driver and above the bus driver.

Filters may work on a certain brand of device such as a mouse or keyboard, or they may perform some operation on a class of devices, such as any mouse or any keyboard. Another type of filter driver is the bus filter driver, which may be added on top of the bus driver. For example, an ACPI bus filter is added to support power management for each device.

Turning to FIG. 5, an example useful for understanding the present invention is shown in which it can be seen that the virtual device software module 40 may be implemented as a filter driver either below the upper filter driver 506 or below the lower filter driver 508.

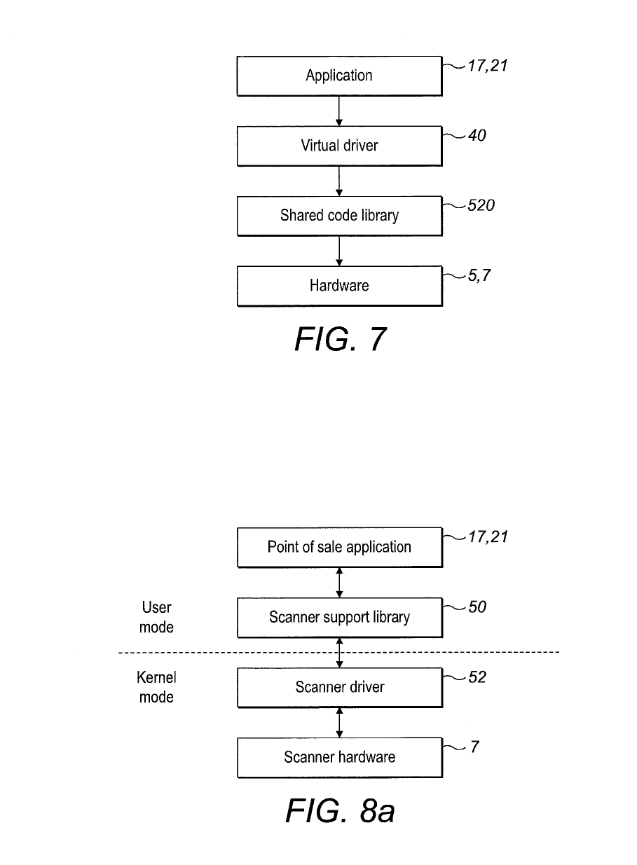

In arrangement (ii), the virtual driver may be implemented as a library that hooks the original API provided by the operating system with its own API hook. The virtual driver 40 may then transfer the API calls to the original library 520 provided by the operating system as shown in FIGS. 6 and 7.

Most OPOS or JAVAPOS service objects end up communicating with the hardware using the hardware driver installed in the OS. In this case, the virtual driver software module 40 may beneficially be installed as a filter driver and in the JAVPOS or OPOS layer. The reason is that changing the drivers stack to add a filter driver may be easier than changing the configurations of JAVAPOS and OPOS layers to accept an extra virtual device in the stack.

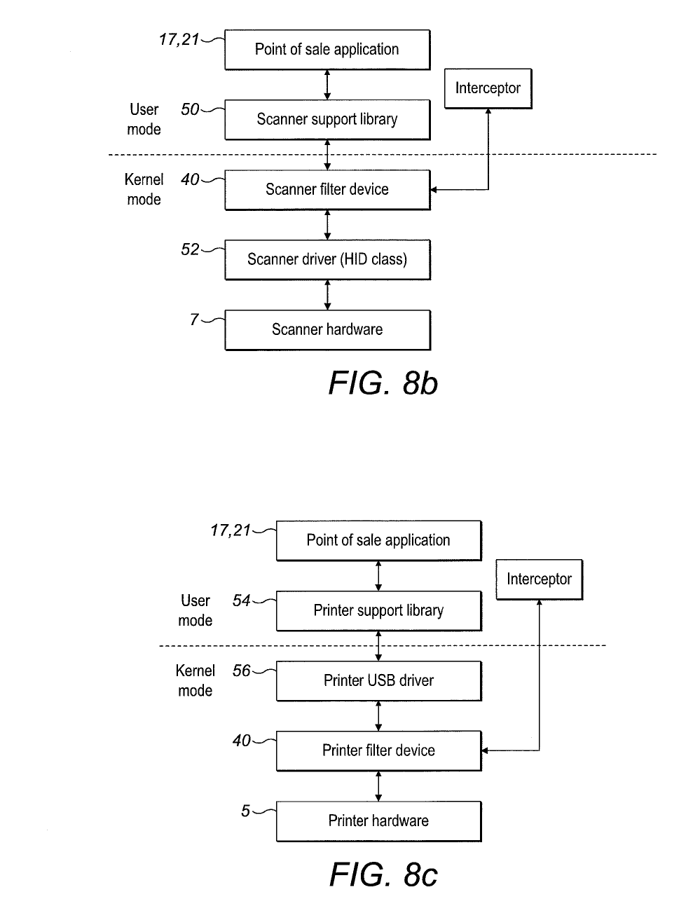

Further POS system arrangements that may be used in conjunction with embodiments of the present invention are shown in FIGS. 8a, 8b and 8c. FIG. 8a shows a scanner arrangement on a known system such as that shown in FIG. 1. A point of sale application (17, 21) located in the user mode of the POS terminal 3 is in communication with a scanner support library 50 (also in the user mode). This library in turn is in communication with a scanner driver 52 and the canner hardware 7.

In FIG. 8 the virtual drive 40 described above is shown. FIG. 8c shows the arrangement for the printer hardware 5 and the arrangement comprises a printer support library 54 and printer USB driver 56.

FIGS. 8b and 8c also show an interceptor module 102 which is explained in more detail below.

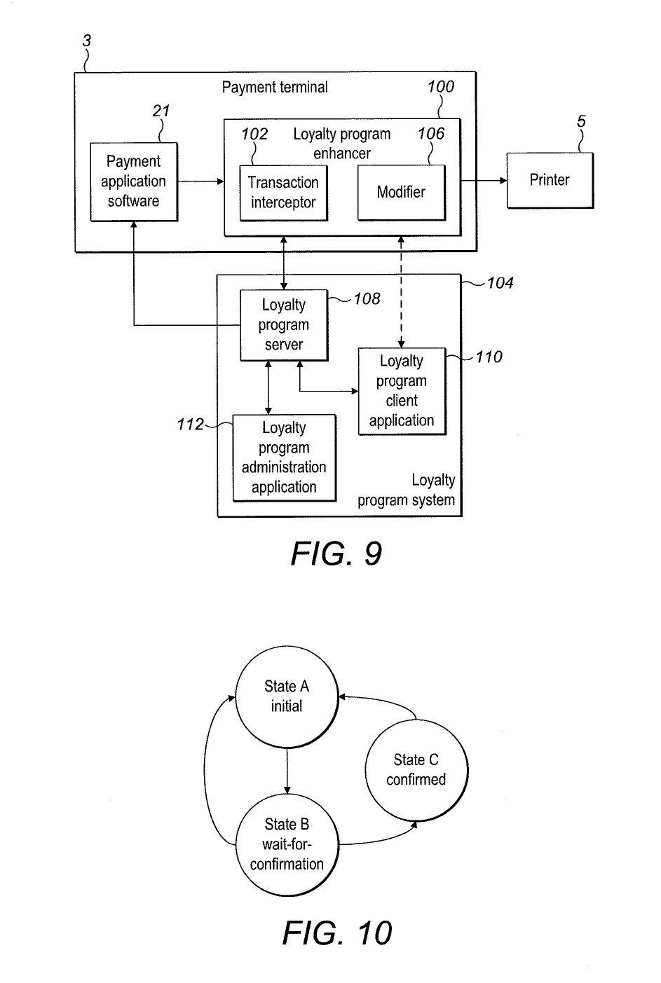

FIG. 9 shows a point-of-sale system in accordance with an embodiment of the present invention. Like reference numerals with the system of FIG. 1 are used to denote like features.

It is noted that within the arrangement of FIG. 9 transaction from the payment application software module data that is directed to the printer 5, passes through an enhancer module 100. The enhancer module comprises an interceptor module 102 which is arranged to intercept the transaction data and send it to a computing system 104. Data that is received from the computing system 104 at the enhancer module 100 may be inserted back into data stream to the printer by the modifier module 106.

The computing system 104 may be located remotely from the payment terminal 3. The computing system 104 comprises further components, namely a loyalty program server 108, a loyalty program client application module 110 and a loyalty program administration application module 112 which are described in more detail below.

The loyalty program server may also be in communication with the payment application software module 21 within the payment terminal 3.

It is noted that the payment terminal 3 may comprise any device that provides access to transaction data, for example a point of sale (POS) terminal, a Proces Data Quickly (PDQ) terminal and electronic commerce systems such as online shops, transaction stores etc.

The payment application software module 21 may be embodied as a Main Payment Terminal Application (MPTA) which corresponds to software responsible for authenticating a transaction or loyalty card, verifying a PIN, and authorising the card for payment.

The printer 5 may comprise any device that is capable of displaying or printing an image. For example a printer in communication with a POS or PDQ terminal, computer displays, smartphone displays or any other display equipped device.

Transaction data sent from the software module 21 to the printer 5 may comprise one or more transaction elements defined as
TRANSACTION_ELEMENT={Transaction-ID, Retailer Name, Branch, Store, Geographic Location, Timestamp, Items, Total Net, Total Include Tax, Total per Category, Credit/Debit Card, Loyalty Card, Voucher, Cash, Offer, Advertisement} where
Transaction-ID—a globally unique identifier of the transaction
Retailer ID, Branch, Store, Geographic Location—location related information.
Timestamp—time stamp of the transaction.
Items—bought items, a set of tuples of form (Item Identifier, Item Description, Amount, Price).
Total Net, Total Include Tax, Total per Category (e.g. GM, Food, etc)—Paid amount related information.
Credit/Debit Card, Loyalty Card, Voucher, Cash—payment type information (e.g. Card Name, hashed PAN, etc).
Offers—a set of offer served at this transaction.
Advertisements—a set of advertisement served with this transaction.

Transaction Data may more formally be defined as element than belongs to a set of all subsets of elements from the set TRANSACTION_ELEMENT except empty set; that is we define a set of transactions as a power set of set TRANSACTION_ELEMENT except empty set:

TRANSACTIONS=P(TRANSACTION_ELEMENT)−Ø, here P(X) means power set of X. A set of TRANSACTION_ELEMENT elements T is called a digital representation of transaction data (or just if transaction data) if T ∈ TRANSACTIONS.

Turning back to FIG. 9, the computing system 104 comprises three components: the a loyalty program server 108, a loyalty program client application module 110 and a loyalty program administration application module 112. These three components in conjunction with the enhancer module 100 within the payment terminal 3 (effectively a fourth, distributed, component) form a loyalty program system. The loyalty program system as described below provides a mechanism for a user to register and obtain an account with the system without the need to enter any additional personal data than is already present during a user transaction.

Within the enhancer module 100, the interceptor module 102 is arranged to intercept data processed by the payment terminal application software module 21. The interceptor module 102 is arranged to communicate with the Loyalty Program Server 108 to maintain user (customer) related information or to associate transactions with users. In one arrangement the interceptor module may be integrated with the payment terminal 3 in order to obtain access to additional information about transactions. As noted above the modifier module 106 is arranged to inject or modify data flowing from Payment Terminal 3 to the Printer 5.

It is noted that the interceptor module 102 and modifier module 106 of FIG. 9 may be implemented using the system arrangements shown in FIGS. 1 to 8 above.

The Loyalty Program Server 108 may be arranged to keep track of various loyalty regard system data such as collected user rewards, redeemed offers, campaigns, user transactions, etc. The Loyalty Program Client Application module 110 and Loyalty Program Enhancer module 112 are arranged to communicate with the loyalty program server 108.

The Loyalty Program Server 108 may comprise a sub-component, Matching Engine module (not shown in FIG. 9), which is arranged to manage loyalty campaigns and reward loyal customers with offers generated in accordance to running campaigns (e.g. “collect 10 points and get a discount”, or “collect 10 stamps and get a free coffee”, etc). (The Matching Engine module may be arranged to use a set of Loyalty-Index functions. These functions measure customer's loyalty degree.)

The Loyalty Program Client Application module 110 is in communication with the Loyalty Program Server 108 and allows users to register with the service, review collected rewards, subscribe to some campaigns, etc.

The Loyalty Program Administrator Application module 112 is arranged to be in communication with the Loyalty Program Server 108 and is arranged to allow the computing system 104 to validate redemptions, associate applications with some Payment Terminal, and perform other administrative tasks.

The Loyalty Program Client application module 110 and the Administrator Application module 112 may be arranged to run on an Internet enabled, scanner equipped, computing device.

User Registration

A user may register with the Loyalty Program Server 108 using an instance of the Loyalty Program Client Application module on a user's computing device and get an account within the system. In such an instance the user would be allocated a customer account ID during the registration process. Embodiments of the present invention however enable a user to be associated with the loyalty system using a unique user identifier associated with their computing device. In this case the user's ID within the loyalty system becomes their device's identifier and they are not required to explicitly register or provide any personal data over and above that which is already included in their transaction history.

The process of establishing a user account (customer profile) on the computing system 104 is described below. It is noted that the following description makes use of a user identifier SUID which is an identifier that is associated with a user transaction card (e.g. a PAN number) or a loyalty card number. As shown in FIG. 10 the SUID described below may be associated with one of three different states within the loyalty system according to embodiments of the present invention. State A is an initial state within the loyalty system. This state is equivalent to the first time the loyalty system encounters a particular SUID. State B is an intermediate state that denotes that an SUID has been encountered by the loyalty system before but that it has not been authorised. State C for an SUID corresponds to a SUID that has been confirmed.

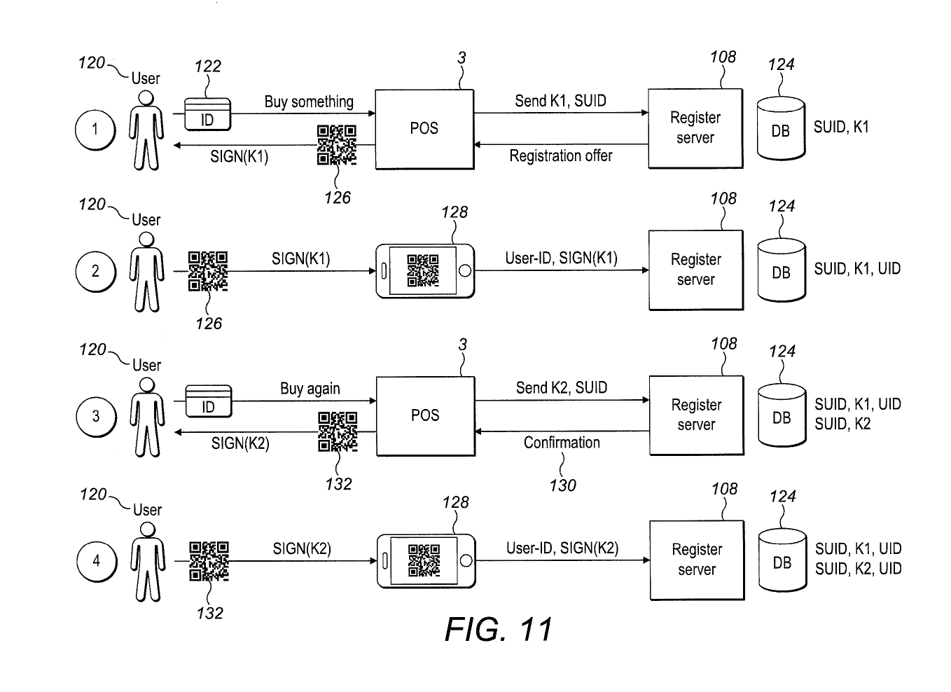

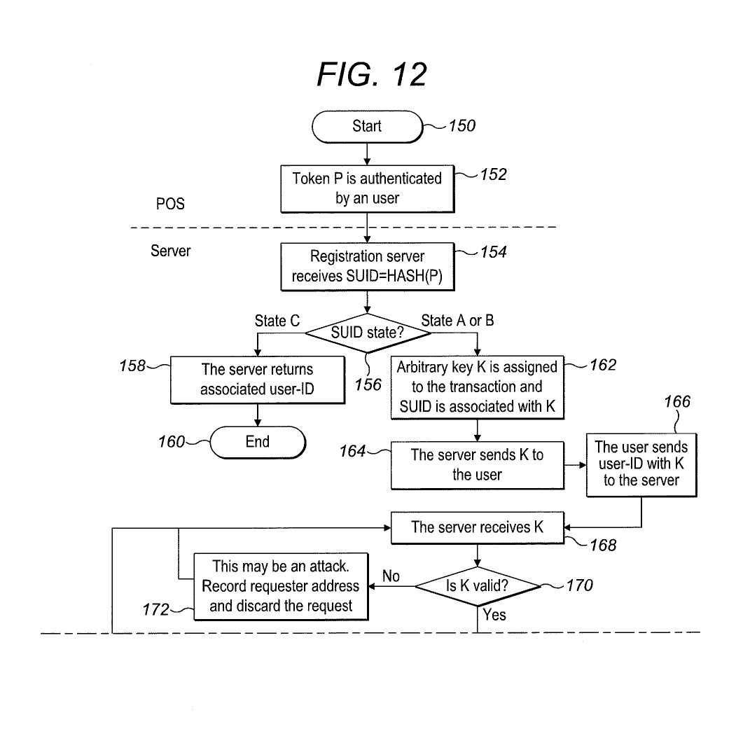

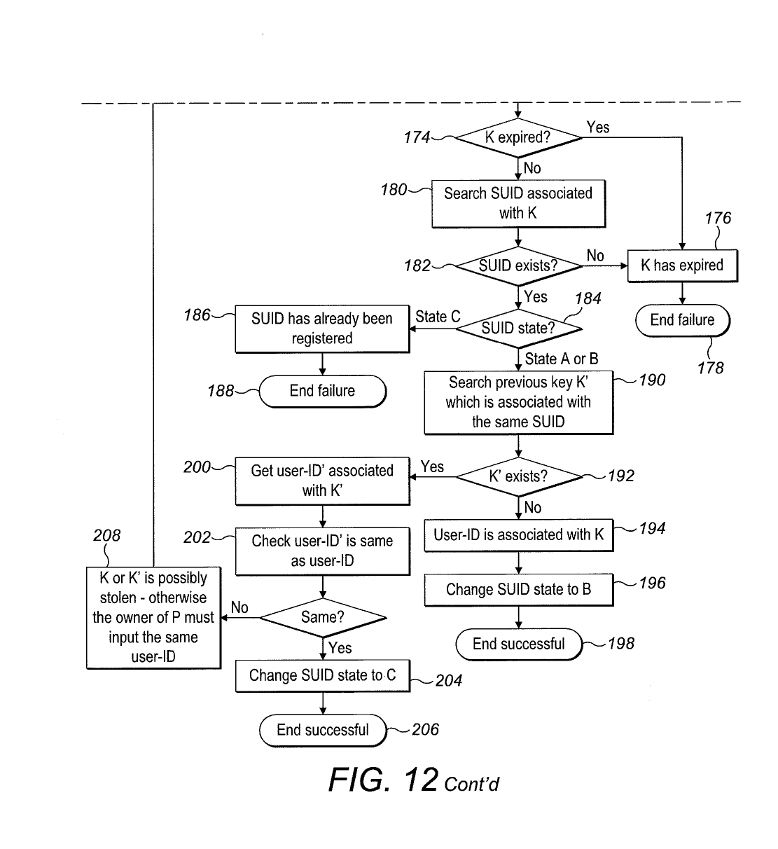

The process of establishing a user account is described in relation to FIGS. 11 and 12. In FIG. 11 a user 120 enters into a transaction, in stage 1, at a payment terminal 3 and uses one of their transaction cards 122 (e.g. a bank card or credit card or loyalty card) during the transaction.

The interceptor module 102 within the point of sale, POS 3, intercepts transaction data comprising the identifier of the transaction card (e.g. the permanent account number (PAN) that appears on the transaction card). The transaction card identifier effectively corresponds to a unique user identifier and the interceptor module 102 is arranged to apply a cryptographic hash function to the identifier. The hashed identifier therefore comprises a customer identifier, herein referred to as the SUID, that may then be sent to the loyalty server 108 without compromising any personal user data.

Note: As described in FIG. 12 the unique user identifier that is provided by the transaction/loyalty card is referred to as a token P that is used to calculate SUID where SUID=HASH(P), where HASH is some cryptographic function. It is noted that in some implementations the cryptographic function may include salt, key-stretching or other technique preventing brute force attacks.

The payment terminal 3/interceptor module 102 is additionally arranged to send a transaction identifier, K1, to the server 108. The server stores the received SUID and transaction identifier K1 in a database 124 and sends in reply a signed copy of the transaction identifier K1 (SIGN(K1)) to the POS terminal 3. The modifier module 106 within the POS terminal 3 is arranged to send the signed identifier to the printer 5 for supply to the user. In the example of FIG. 11 the signed identifier is printed as a two dimensional barcode 126.

If the SUID received by the server 108 has not previously been supplied to the server 108 before then the server classes the SUID as being in state A.

In stage 2 of the process the user 120 scans the printed signed identifier (SIGN(K1)) using their user computing device 128, e.g. a smartdevice such as a smartphone or tablet that comprises suitable software and image capture features. The user computing device will be associated with a device identifier (user-ID) and the computing device 128 is arranged to send both the user-ID and the scanned barcode 126 data (i.e. data corresponding to the signed transaction identifier, SIGN(K1)) to the server 108.

Note: in the embodiments of the present invention described below the user (customer) uses their computing device (smartphone, tablet etc) to use the loyalty system 104. The benefit of this approach is that the user does not need to enter any personal data over and above that which is already present in their transactions. In such cases the user-ID that is associated with their user profile within the loyalty system 104 equates to their computing device's unique identifier (e.g. an IMEI number). In alternative embodiments a user may use a loyalty program client application module 110 (which may be installed on their computing device or accessed on any computing device, e.g. via a browser) to complete a more tradition signup process to the loyalty system. In such embodiments the user-ID would be an account ID generated by the loyalty system 104.

The server 108 is arranged to store the user-ID in the database 124 along with the customer identifier (SUID) and transaction identifier (K1).

Stage 2 of the process corresponds to the user indicating that they wish to utilise the loyalty system. At the end of stage 2 the server 108 has sufficient data associated with the user 120 to open populate a customer profile. The hashed transaction card identifier (SUID) is moved from state A to state B at the end of this stage to indicate that the user 120 has indicated a desire to join the system.

It is noted that the scanning of the barcode 126 by the user 120 in stage 2 may be associated with an expiry period. For example, the server 108 may, on receipt of the SUID and K1 data in stage 1, set an expiry period within which the user should perform stage 2 in order to continue with the process of establishing a customer profile.

In the embodiment of FIG. 11 the customer profile requires two further stages (stages 3 and 4) to occur until the user's profile is fully active. Stages 3 and 4 therefore represent a confirmation process to double check that the user wishes to sign up to the system and to prevent or reduce the instance of fraudulent uses of the loyalty system. As described below stages 3 and 4 in FIG. 11 are similar to stages 1 and 2. However, it is to be appreciated that alternative confirmation processes may be used. For example following the completion of stage 2 a user may receive a request from the server to enter information that would only be known to the owner of the unique user identifier (for example the expiry date of a transaction card and/or a complete transaction card or loyalty card number). As a further alternative a user may be allowed to register with the loyalty system using stages 1 and 2 only but may be subject to periodic confirmations where they are required to follow the process of stages 1 and 2 again. This could be done on a periodic time interval or after a given number of transactions.

In FIG. 11 in order for the user to confirm they wish to use the loyalty system a further transaction and subsequent scanning stage is applied. Therefore in stage 3 a further transaction occurs using the same transaction card (therefore the same customer identifier SUID is generated for transmission to the server 108). The SUID sent to the server 108 from the POS 3 is accompanied by a second transaction identifier K2 and the server 108 is arranged to store the second instance of the SUID and identifier K2 in the database 124.

The server 108 is then arranged to send a confirmation message 130 containing a signed copy of the transaction identifier K2 back to the POS 3 (i.e. the server returns SIGN(K2)). The POS 3 is arranged to send the signed transaction identifier SIGN(K2) to the user, e.g. via the printer 5 and a further barcode 132. The server 108 may again associate an expiry period within which the user should perform stage 4.

In stage 4 the user scans the barcode 130 and sends this via their user computing device 128 to the server. The user computing device therefore sends SIGN(K2) along with its own identifier, user-ID, to the server which can check that the user-ID received in stage 4 matches the user-ID in stage 2 and that the SUID used in stage 1 matches that used in stage 3. If all the information corresponds then the server 108 updates the SUID to stage C (confirmed) and creates an active customer profile in the database. The profile comprises an association between the user's transaction card (represented by the SUID) and the user's computing device (represented by user-ID).

It is noted that further transaction cards used by the user may be associated with this profile in the same manner such that the user's computing device (user-ID) is associated with multiple transaction cards.

The user's computing device may comprise an instance of the client application module 110 shown in FIG. 9.

FIG. 12 shows the process of FIG. 11 mainly from the point of view of the server 108.

In step 150 the process begins and in step 152 the POS terminal 3 authenticates token P. Token P may comprise a transaction card PAN and step 152 therefore represents the transaction card within a transaction authorisation process.

The process then moves to step 154 which occurs on the server 108. In step 154 the server 108 receives the SUID, the customer identifier that resulted from the cryptographic hashing of the token P on the payment terminal 3. The SUID is received from the interceptor module 102.

In step 156 the server 108 checks the state of the SUID as stored in the database 124. If the SUID corresponds to a transaction card that has already been registered then the database entry for the SUID will indicate it is in state C. The server 108 may then retrieve the associated customer profile from the database.

In an arrangement where the user has registered with the system in accordance with FIG. 11 then the SUID will be linked in the customer profile with the user's computing device ID, i.e. the user-ID will be the identifier of the user's computing device (e.g. an IMEI number).

In an alternative arrangement the user may have formally registered with the system via a traditional log in and registration form. In such an alternative arrangement the user-ID may be comprise a unique reference number generated by the server 108.

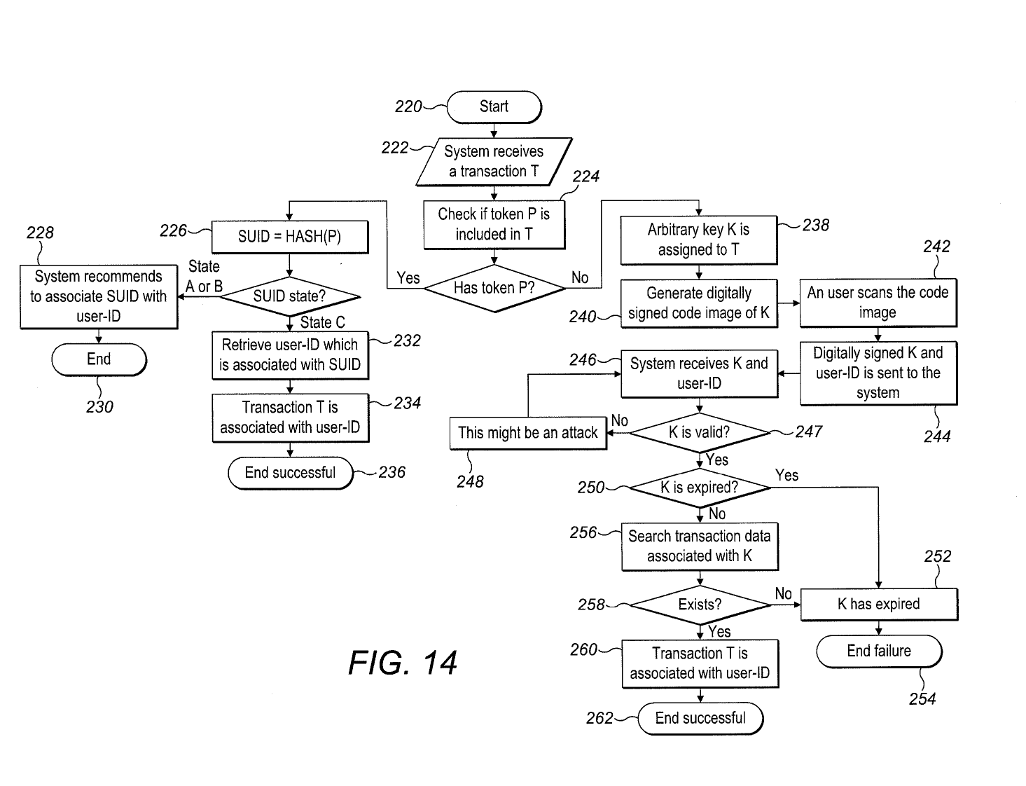

In either arrangement the server 108 is arranged in step 158 to retrieve the user-ID and the process either ends in step 160 or transfers to a further process for storing the user's transaction history [as described in relation to FIG. 14 below]

As noted above the server 108 checks the state of the SUID stored in the database 124. If the SUID is in state A (indicating that this is the first time that the server 108 has encountered this particular transaction card) or state B (indicating that the transaction card has been encountered before but has not been confirmed) then the server moves to step 162.

As noted in reference to FIG. 11 above the POS terminal 3 will assign an arbitrary transaction identifier to each transaction and sends this in stage 1 of FIG. 11 to the server 108 along with the SUID. In step 162 the server 108 determines the transaction identifier (K) and associates this with the SUID in the database 124.

In step 164 the server 108 sends the transaction identifier back to the user. As noted in FIG. 11 this may be achieved by including a barcode within the transaction receipt. It is also noted that the identifier K may be signed by the server 108 to indicate that it has originated from an authentic source (the server 108).

In step 166 the server 108 receives a communication from the user which contains the transaction identifier K and a user-ID (e.g. an identifier of the user's computing device).

In step 168, the server 108 extracts the transaction identifier K and, in step 170 checks if it is valid.

If the transaction identifier is not valid then in step 172 the server 108 may determine that a fraudulent attempt is being made to register with the loyalty system. The address of the user sending the user-ID may be recorded and the request may be discarded.

If the transaction identifier is valid then in step 174 the server 108 determines if the transaction identifier K has expired. If the identifier K has expired then the server moves to step 176 and notes the expiry of the identifier and then proceeds to end the loyalty sign-up process in step 178.

If the transaction identifier K has not expired then in step 180 the server 108 searches the database 124 to determine the SUID is associated with the transaction identifier K. It is noted that the SUID in step 180 will be in stage 2 of the registration process shown in FIG. 11 (the SUID in step 154 above will be in stage 2 of the registration process shown in FIG. 11).

If there is no SUID then the server 108 moves to step 176 and then terminates the sig-up process in step 178.

If an SUID exists then in step 184 the state of the SUID is determined. If the SUID is in state C then in step 186 the server 108 determines that the SUID has already been registered and confirmed and the sign-up process ends in step 188.

If the SUID is determined to be in state A or sate B then the server then searches, in step 190, to see if a previous transaction identifier, K’, is associated with the same SUID.

If no previous transaction identifier, K′, is known then in step 194 the user-ID received in step 166 is associated with the transaction identifier K. The state of the SUID is then updated to state B in step 196 and the process terminates at step 198. Once the SUID has been placed into state B then the process requires a user to undertake another transaction with the same transaction card (i.e. the same SUID) in order to complete the signup process and move the SUID to state C.

If, in step 192, a previous transaction identifier K′ is found then the user identifier associated with the previous transaction identifier is retrieved in step 200 (i.e. retrieve user-ID′).

In step 202 the user-ID received in step 166 is compared to the previous user-ID′ retrieved from the database 124.

If the user identifiers match (user-ID=user-ID′) then in step 204 the server 108 changes the SUID state to state C and then the signup process completes in step 206.

If the user identifiers do not match (user-ID≠user-ID′) then one or other of the transactions may be fraudulent. Alternatively, the user may have used different devices to perform the stage 2 and stage 4 scanning in FIG. 11.

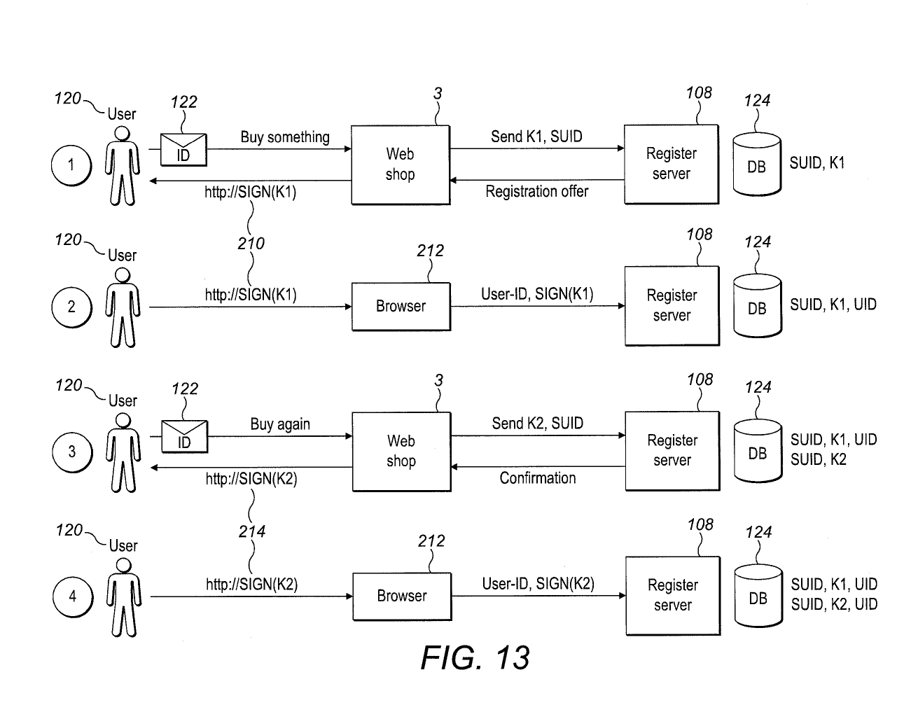

As an alternative to issuing a barcode for scanning the loyalty system 104 may be arranged to issue a one time password to the user for manual entry by the user. This alternative arrangement is shown in FIG. 13.

It is noted that the process steps shown in FIG. 13 are closely related to FIG. 11. As such the common elements between FIGS. 11 and 13 will not be restated. However, the following differences are noted.

Instead of a point of sale terminal FIG. 13 shows a user making a transaction via an online store (web shop 3). The online store however may be regarded as functionally similar to the POS terminal of FIG. 11 and both the POS terminal and online stores are regarded as examples of payment terminals within the context of embodiments of the present invention.

As an alternative to a barcode the server 108, in FIG. 13, issues a one-time password 210 back to the user in stage 1. This password may be entered in stage 2 into the user's computing device via the loyalty program client application 110. Alternatively, as shown in FIG. 13, the password may be entered via a browser 212.

It is also noted that in a yet further arrangement it may be possible to modify the software on the payment terminal 3 to an extent that the normal transaction process can be modified to as a user (customer) if they want to register their transaction card with the loyalty system 104. In this arrangement the association of the SUID and user-ID shown in steps 1-4 in FIGS. 11 and 13 may be done in a single step at the payment terminal 3 (e.g. the PDQ/POS terminal may, during the transaction such as before the PIN entry stage, ask the customer if they want to register with the loyalty program.)

The process described above in relation to FIGS. 10 to 13 establish a customer profile within the loyalty system 104 in which a user-ID (either in the form of a computing device's unique identifier or a system generated identifier) is associated with a transaction card (via the SUID corresponding to that transaction card). The processes of FIGS. 10 to 13 may be repeated for multiple transaction devices such that the user-ID is associated with multiple SUIDs.

Once a SUID to user-ID relationship has been established, further transactions made by the user may be captured by interceptor modules 102 installed in payment terminals 3 that have been subscribed with the loyalty system 104. The user's transaction history may then be captured and stored in the database 124 thereby allowing loyalty awards to be assigned to that user.

FIG. 14 shows the process of capturing further transactions once an association between a user-ID and an SUID has been made.

In step 220 the subsequent transaction capture begins and at step 222 the server 108 receives details of a transaction from a payment terminal 3. In step 224 the server 108 checks to see if a token P is present within the data sent from the payment terminal 3. As noted above the token P may be a personal account number (PAN) of a transaction card or a loyalty card number. Also as noted above this token P is received in the form of a cryptographically hashed version of the token (the SUID discussed above).

It is noted that a token P/SUID may not be present in the transaction data received from the payment terminal 3 in cases where the user has concluded the transaction using cash.

If a token P/SUID is present then in step 226 the server 108 retrieves the SUID from the transaction data and checks the state of the SUID.

In the event that the SUID is in state A or state B then the server 108 may output a recommendation that the SUID should be associated with a user-ID. The process then ends in step 230.

In the event that the SUID is in state C then in step 232 the server 108 retrieves the user-ID associated with the SUID. In step 234 the transaction details received from the payment terminal 3 are associated with the user-ID and stored in the database 124. The process then ends in step 236.

In the event that no token P is present in the transaction data then in step 238 an arbitrary key K is assigned to the transaction (T). A digitally signed copy of the key K is then generated in step 240 and sent to the user (e.g. via the printer receipt). In step 242 the user may scan the digitally signed copy of the key K that appears on the receipt. For example the key may be embodied within a two dimensional barcode on the receipt that the user can scan with their computing device.

In step 244 the scanned image and the user's user-ID are sent to the server 108. In step 246 the server 108 receives the transaction identifier K and user-ID and checks, in 247, if the key K is valid. If the key is not valid then in step 248 the server 108 flags the transaction as potentially fraudulent.

In step 250 the server then checks if the key K has expired. If it has expired then the server notes this in step 252 and then ends the process in step 254.

If the key K has not expired then the server 108 moves to step 256 and searches for transaction data associated with the key K (e.g. transaction data that has been sent in step 242 from the user when they scan the receipt for the transaction T).

If no transaction data is present then the server moves via step 252 to terminate the process in step 254. However, if transaction data is present then in step 260 the server 108 associates the transaction T with the user-ID and then the process terminates in step 262 until further data is provided.

It is noted that in an alternative to the process shown in FIG. 14 the receipt delivered to the user may comprise a one time password which may be entered by the user in place of scanning a barcode in step 242.

The process of establishing a user profile within the loyalty system 104 and associating subsequent transaction details with that profile has been described above.

At the point when transaction data has been associated with an SUID and the User-ID within the user/customer profile, the Loyalty Program Server 108 may evaluate a customer's loyalty by calculating a loyalty index based on the customer profile and all other information associated with User-ID.

At some point the Loyalty Program Server 108 may issue an offer depending on the Issuance Conditions associated with the offer. An issued offer would have Reward Meta-data associated with it and may also include Issuance Transaction Elements, Issuance Conditions, Redemption Conditions, Redemption Passcode and Expiry. After the customer has redeemed the offer, the offer will include a Redemption Transaction attribute in its Reward Meta-data.

Within the context of the following discussion the following terms are used:
Offer (Reward): Offer is an incentive given to a loyal customer. (E.g. free coffee if you have collected 10 stamps etc.). “Reward” and “Offer” will be used interchangeably.
Customer Profile is a data structure that contains all relevant information associated with User-ID. It holds all SUIDs associated with User-ID, and all transaction data associated with each of those SUIDs. Also, it includes rewards associated with User-ID, and each reward has Reward Meta-data associated with it. (FIG. 12)
Loyalty-Index Function is a function that takes as argument Customer Profile and return loyalty index that is used to decided if an offer should be issued to this customer. (E.g. some Loyalty-Function might return a number of “stamps” collected; when some number of “stamps” has been collected, customer gets an offer.)
Reward Meta-data: Reward Meta-data of an offer is a set of attributes as follows:
   Redemption Passcode is a unique ID of the offer.
   Issuance Transaction Elements which is a set of element from transactions that have been used to trigger the offer (e.g. 10 transaction elements Caffe Latte). Every transaction element has a reference to the transaction it is coming from.
   Issuance Conditions is a set of criteria that should be met in order to trigger an offer (e.g. 10 points). All issuance conditions have references to the corresponding campaigns.
   Redemption Transaction is a transaction where this offer was redeemed.
   Redemption Conditions is a set of criteria that should be met in order to redeem this offer.
   Expiry is a date when this offer expires.

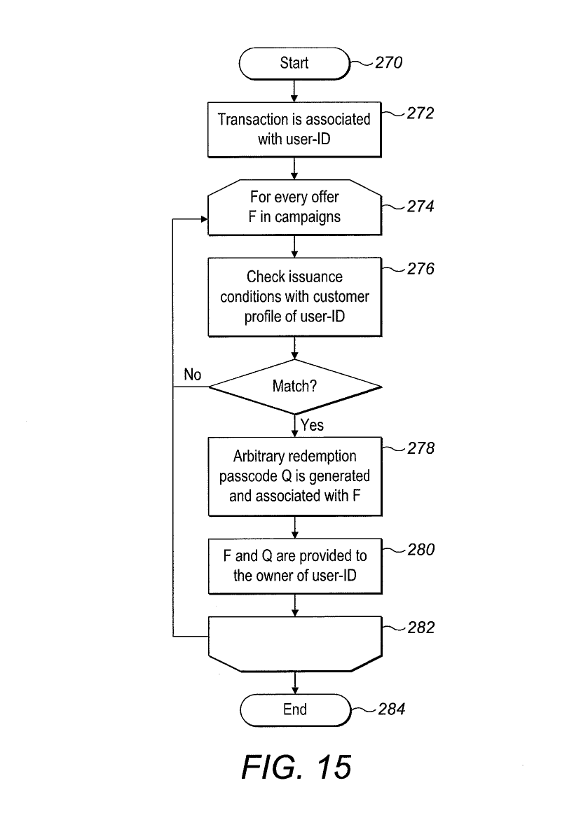

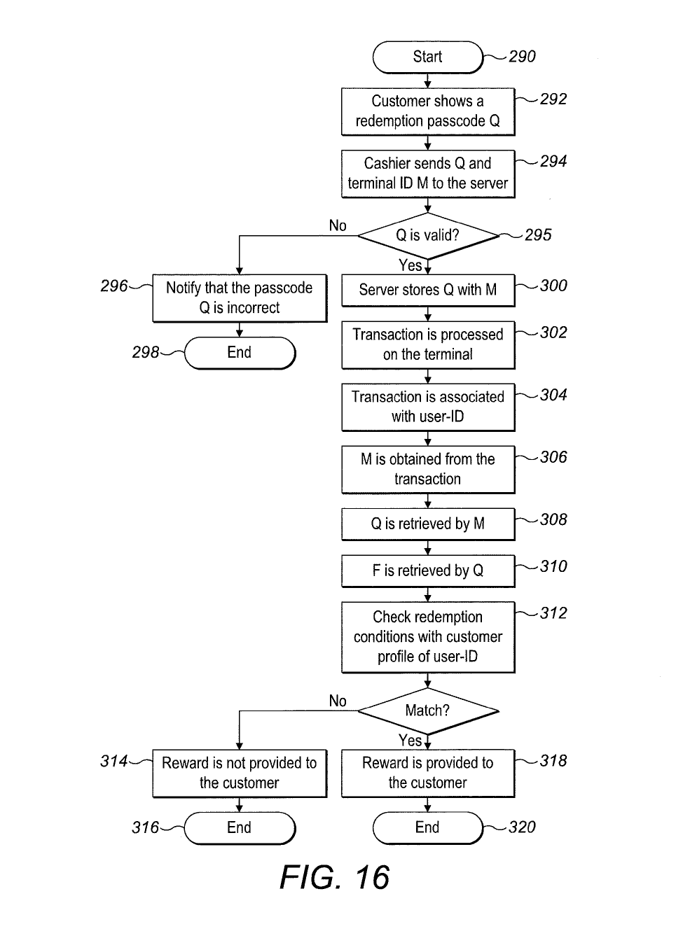

The process of reward/loyalty validation and redemption is shown in FIGS. 15 and 16 which describe how the Loyalty Program Server measures a customer's loyalty and checks offer issuance conditions (e.g. 10 stamps collected, or 20 points collected etc), and if these conditions are satisfied, provides a randomly and uniquely generated Redemption Passcode that must be given to the cashier in store A in order to redeem an offer or get a discount.

Turning to FIG. 15 the process of issuing a reward is shown. The process begins in step 270 when the loyalty server 108 receives transaction data from the interceptor module 102 in the payment terminal 3. In step 272 this transaction is associated with the user-ID that has been set up in accordance with the processes in FIGS. 10 to 14.

The loyalty server 108 will have access to a plurality of offers F that have been uploaded to the system 104 via the administration application 112. In step 274 an offer F is selected and in step 276 the issuance conditions associated with that offer are checked with the transaction history and customer profile of user-ID.

If there is no match then the server 108 moves back to step 274 and selects another offer F to check.

If there is a match then in step 278 an arbitrary redemption passcode Q is generated by the server 108 and associated with the offer F. The offer F and passcode Q are then sent to the user associated with the user-ID in step 280. The offer F and passcode Q may be sent to the user by any convenient means (e.g. via a POS terminal receipt, via a web page that is linked to the user's profile, via a communication to a user's mobile device etc.

In step 282 the process may either loop back round to step 274 to assess further offers held within the loyalty system or may process to step 284 where the process ends.

The process of redeeming an offer is shown in FIG. 16. The process begins in step 290 with the initiation of a transaction. In step 292 the customer shows the passcode Q generated in step 278 above. In step 294 the payment terminal operator scans or enters the passcode Q which is then sent along with the payment terminal identifier M to the server 108. In step 295 the server checks if the passcode is valid.

If the passcode is invalid then in step 296 the terminal/operator/customer is notified and the process terminates in step 298.

If the passcode is valid then the server 108 is arranged to store the passcode and terminal identifier M.

In step 302 the transaction data relating to the transaction between the store and the user is received from the payment terminal 3 and in step 304 the transaction data is associated with the user-ID.

In step 306 the server 108 retrieves the terminal identifier from the received transaction data and in step 308 retrieves the stored passcode Q. In step 310 the passcode Q is used to retrieve the associated offer F and in step 312 the redemption conditions for that offer are checked against the customer profile.

If the redemption conditions do not match the customer profile then the reward is not provided to the user in step 314 and the process terminates in step 316. If there is a match however then the reward is provided to the customer 318 and the process again terminates in step 320.

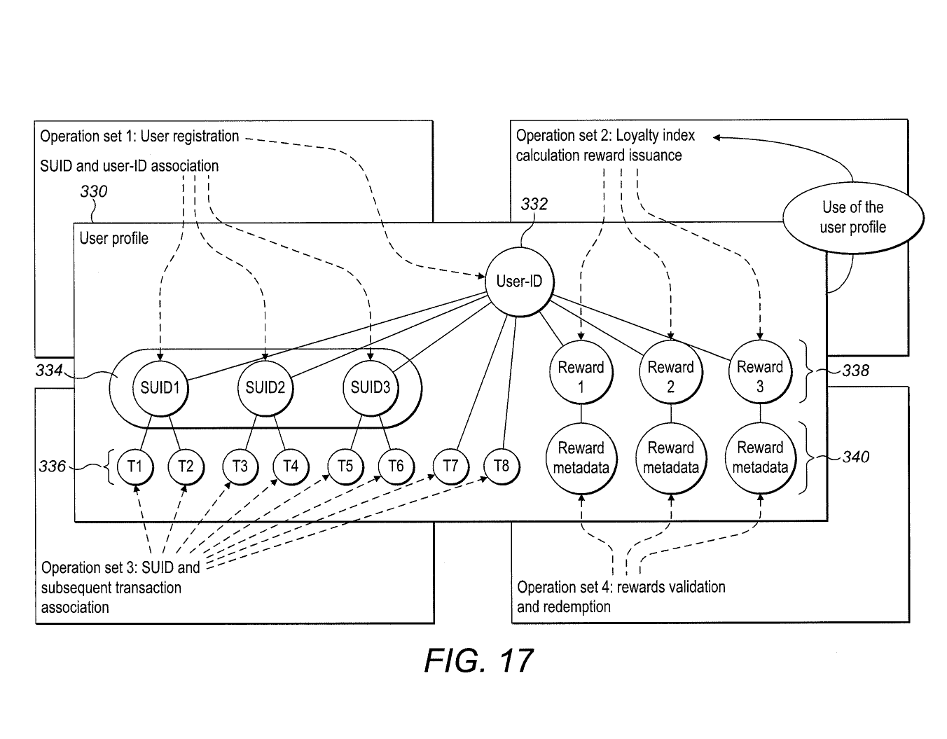

FIG. 17 is a representation of the user profile that is generated and used as described above in relation to FIGS. 10 to 16.

The user profile 330 comprises a user-ID 332 (which as described above may relate to a user's computing device's identifier or may be generated by the loyalty system 104). The user-ID 332 is associated with three different transaction cards 334 as represented by the cryptographically hashed values SUID1, SUID2 and SUID3. A number of transactions 336 are shown. It is noted that transactions T1 through T6 are associated with one of the transaction cards 334. Transactions T7 and T8 however represent cash transactions.

The user-ID 332 is also associated with rewards 338 that have been applied to the user profile in accordance with the user's transaction history.

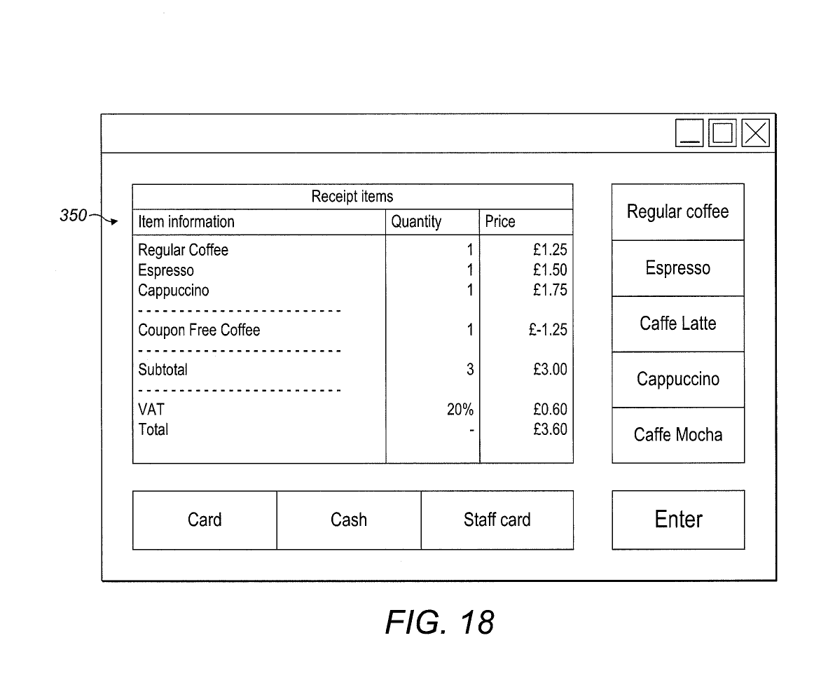

FIGS. 18 to 22 show example screenshots of an application (a loyalty program administrators application) installed on a POS terminal 3.

When a user comes to redeem an offer they provide their redemption passcode to the operator of a payment terminal 3 in a store A, who then uses the Internet enabled payment terminal to validate the given Redemption Passcode. The cashier logs in to the system using an administrator's account. The cashier is presented with an interface (see FIGS. 18 to 22 below) where this code can be typed in or scanned. The application that the cashier uses is associated with the Payment Terminal 3 and communicates with the Loyalty Program Server 108.

During a transaction the customer gives their Redemption Passcode to the payment terminal operator who either scans it or enters into administrator's application. Since this administrative application is associated with the Payment Terminal it makes it possible to automatically associate the next transaction from the given terminal with this supplied Redemption Passcode. This can be achieved by sending a special command to the Loyalty Program Server with the given Payment Terminal identifier and Redemption Passcode. The server will be ready to associate the next transaction from this Payment Terminal with the given Redemption Passcode provided given Redemption passcode is valid (Loyalty Program Server will check validity of Redemption Passcode and inform the cashier correspondingly).

Note: Instead of using a special application be installed on the payment terminal it would be possible to use the cashier's mobile phone etc. that would perform exactly the same functions like administrative application described above.

Redemption Passcode is always associated with the transaction at which the redemption took place (this is Redemption Transaction of Reward Meta-data). Reward Meta-data also includes Issuance Transaction Elements and Issuance Conditions which allows to check if this reward was legitimately issued by reviewing Issuance Transaction Elements and Issuance Conditions. In addition to that, Redemption Transaction and Redemption Conditions can also be checked once the offer has been redeemed.

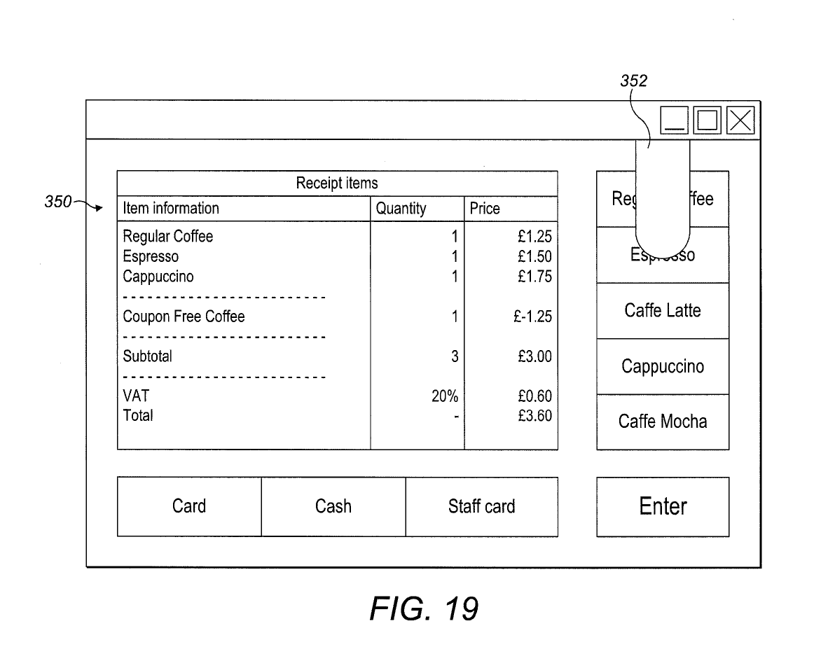

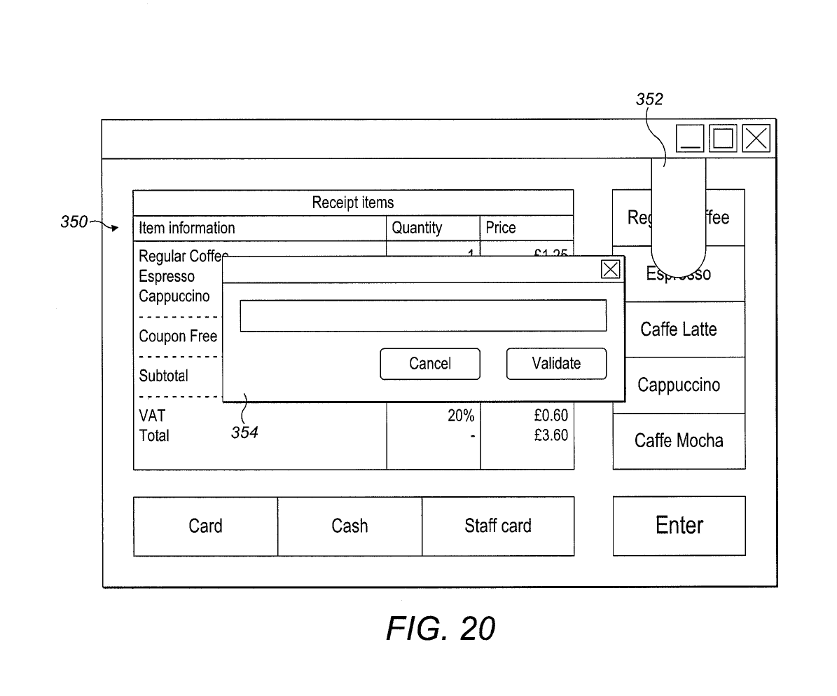

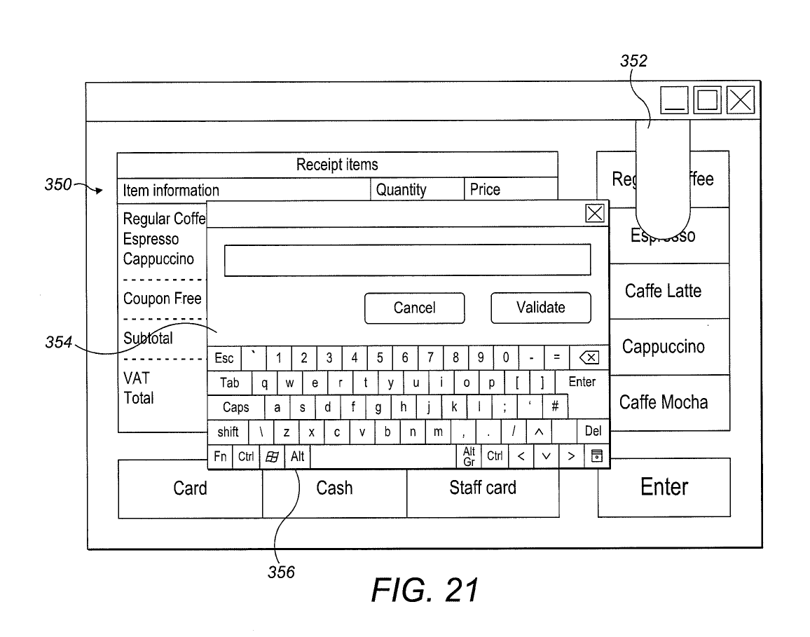

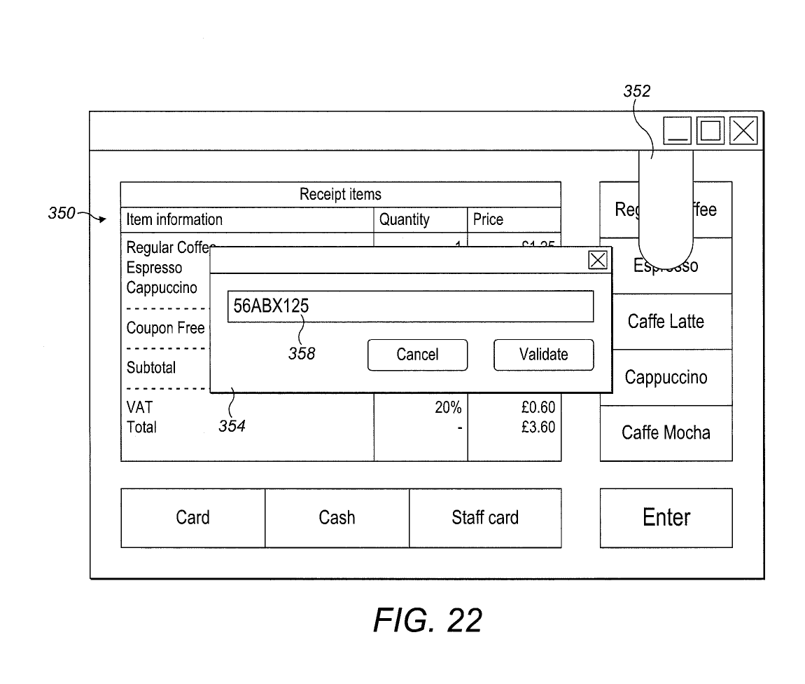

Turning now to FIGS. 18 to 22, a special application (Loyalty Program Administrators Application, LPAA) is installed on the POS Terminal. In FIG. 18 the LPAA is inactive and the POS terminal screen displays its standard output. When the Loyalty Program Administrator Application (LPAA) is active, a bookmark-like button 352 becomes visible (FIG. 19). A cashier may click on the button 352 to open a window 354 as depicted in FIG. 20. The Cashier may now enter a redemption passcode via a keyboard 356 (see FIG. 21) so that the code 358 may be validated (see FIG. 22).

Note: Within the POS Terminal 3 the MPTA and LPAA may be installed and run side-by-side. The LPAA integrates with MPTA by enhancing the MPTA with an ability to invoke LPAA , for example by tapping/clicking on a special button or by doing some unique gesture; or some specific area of the display can be tracked for specific gestures or taps or taps and gesture combinations; in addition to that, keyboard keys combination or a special keyboard key can also be used to invoke LPAA; it should be understood that basically any computer input devices such as mouse, keyboard, touch-enabled displays, microphones, motion sensing input device, etc. can be used to invoke LPAA from MPTA.

Where a customer has been given an offer and redemption passcode, the redemption passcode can be viewed using customer's mobile computing device.

It will be understood that the embodiments described above are given by way of example only and are not intended to limit the invention. It will also be understood that the embodiments described may be used individually or in combination.

1. A method of establishing a user profile on a server computer, the user profile being associated with a unique user identifier used during a transaction made by a user, the method comprising:
receiving user-related data comprising identification data associated with the unique user identifier;
sending a server authentication message to the user in dependence on the user related data;
receiving a registration message from the user, the message comprising the authentication message;
establishing the user profile in response to receiving the registration message.

2. A method as claimed in claim 1 , wherein the user-related data comprises a transaction identifier relating to the transaction.

3. A method as claimed in claim 1, wherein the registration message comprises a unique device identifier corresponding to a user computing device.

4. A method as claimed in claim 1, comprising receiving further user- related data comprising identification data associated with the unique user identifier; sending a further server authentication message to the user in dependence on the further user related data; receiving a further registration message from the user, the message comprising the further authentication message; confirming the user profile in response to receiving the further registration message.

5. A method as claimed in claim 4, wherein the further user-related data comprises a further transaction identifier relating to a further transaction.

6. A method as claimed in claim 2, wherein transaction identifiers are assigned by a payment terminal to a transaction, each transaction being assigned a different transaction identifier.

7. A method as claimed in claim claim 1, wherein the unique user identifier comprises an account number associated with a user transaction device.

8. A method as claimed in claim 1, wherein the unique user identifier comprises an account number associated with a user loyalty card.

9. A method as claimed in claim 1, wherein the identification data received by the server computer comprises a cryptographically hashed version of the unique user identifier.

10. A method as claimed in claim 1, wherein the server computer associates the received identification data with an initial status flag.

11. A method as claimed in claim 10, wherein the server computer is arranged to update the status flag to a pending status upon receipt of the registration message.

12. A method as claimed in claim 11, wherein the server computer is arranged to update the status flag to a confirmed status upon receipt of a further registration message.

13. A method as claimed in claim 1, wherein the authentication message comprises a digitally signed copy of the transaction identifier and wherein the server computer verifies the validity of the transaction identifier received in the registration message.

14. A method as claimed in claim 1, wherein the user-related data comprises transaction data and the server computer is arranged to store the transaction data.

15. A method as claimed in claim 1, wherein the server authentication message is sent to a payment terminal.

16. A method as claimed in claim 1, wherein the server authentication message comprises a passcode.

17. A method as claimed in claim 1, wherein the server authentication message comprises an image.

18. A method as claimed in claim 17, wherein the image comprises a two dimensional barcode.

19. A method of processing transaction data in dependence a user profile, the user profile having been established according to the method of claim 1, the method comprising:
receiving transaction data related to a user transaction;
storing the received transaction data and associating the received transaction data with the user profile to create a transaction history for the user.

20. A method as claimed in claim 19, comprising comparing the transaction history of the user against a stored transaction offer, the transaction offer being associated with an issuance condition, and issuing the offer to the user in the event that the issuance condition is satisfied by the transaction history of the user.

21. A method as claimed in claim 20, wherein the transaction offer is sent to a user computing device.

22. A method as claimed in claim 20, wherein the transaction offer is sent to a payment terminal.

23. A carrier medium for carrying a computer readable code for server computer to carry out the method of claim 1.

24. A server computer arranged to establish a user profile, the user profile being associated with a unique user identifier used during a transaction made by a user, comprising:
an input;
a processor;
an output;
wherein the input is arranged to receive user-related data comprising identification data associated with the unique user identifier, the processor is arranged to generate a server authentication message in dependence on the user related data and the output is arranged to send the server authentication message to the user, and
wherein the input is arranged to receive a registration message from the user, the message comprising the authentication message and the processor is arranged to establish the user profile in response to the registration message.

25. A server computer arranged to process transaction data in dependence a user profile, comprising a server computer as claimed in claim 24 wherein the input is arranged to receive transaction data related to a user transaction and the processor is arranged to store the received transaction data and associate the received transaction data with the user profile to create a transaction history for the user.

26. A method of establishing a user profile on a server computer, the user profile being associated with a unique user identifier used during a transaction made by a user on at a payment terminal, the method comprising:
sending user-related data comprising identification data associated with the unique user identifier from the payment terminal to the server computer;
sending from the server computer a server authentication message to the user in dependence on the user related data;
sending a registration message from the user to the server computer, the message comprising the authentication message;
establishing the user profile in response to receiving the registration message at the server computer.
